(19) United States
(12) Patent Application Publication
(10) Pub. No.: US 2016/0306305 A1
(43) Pub. Date: Oct. 20, 2016

(54) IMAGE FORMING APPARATUS, IMAGE FORMATION SYSTEM AND HEATING CONTROL METHOD

(71) Applicant: Konica Minolta, Inc., Tokyo (JP)

(72) Inventor: Takashi YAMADA, Tokyo (JP)

(21) Appl. No.: 15/097,633

(22) Filed: Apr. 13, 2016

(30) Foreign Application Priority Data
Apr. 17, 2015 (JP) 2015-085053

(51) Int. Cl. G03G 15/20

(52) U.S. Cl. CPC G03G 15/2039

(57) ABSTRACT

An image forming apparatus includes: a fixing member; a plurality of airflow generation members configured to generate airflows, the airflows being different from each other in influence on a temperature of the fixing member in an axis direction; a temperature detection section configured to detect the temperature of the fixing member; and a control section configured to control a heating amount of the heating section on a basis of the temperature detected by the temperature detection section and a target temperature of the fixing member. The control section controls the heating amount of the heating section in accordance with operation statuses of the airflow generation members such that the temperature of the fixing member in the axis direction is uniform.

### CROSS REFERENCE TO RELATED APPLICATIONS

This application is entitled to and claims the benefit of Japanese Patent Application No. 2015-085053, filed on Apr. 17, 2015, the disclosure of which including the specification, drawings and abstract is incorporated herein by reference in its entirety.

### BACKGROUND OF THE INVENTION

1. Field of the Invention

The present invention relates to an electrophotographic image forming apparatus, an image formation system and a heating control method.

2. Description of Related Art

In general, an electrophotographic image forming apparatus (such as a printer, a copy machine, and a fax machine) is configured to irradiate (expose) a charged photoconductor with (to) laser light based on image data to form an electrostatic latent image on the surface of the photoconductor. The electrostatic latent image is then visualized by supplying toner from a developing device to a photoconductor drum (image carrier) on which the electrostatic latent image is formed, whereby a toner image is formed. Further, the toner image is directly or indirectly transferred to a sheet, and then heat and pressure are applied to the sheet at a fixing nip of a fixing device to form an image on the sheet.

A technique for controlling the temperature of a fixing device has been proposed in which two heaters whose light distribution relative to a fixing roller in the longitudinal direction is composed of a low light distribution range, a rising range, a high light distribution range, and a peak range are disposed in opposite directions such that their rising ranges overlap each other, and a thermistor (detection section) is provided at a position near each peak range to control the two heaters such that the difference between detection temperatures of the detection sections falls within a predetermined range (see, for example, Japanese Patent Application Laid-Open No. 7-114294).

An image forming apparatus is often provided with different kinds of airflow generation members (fans) such as a fixation cooling fan for cooling down a fixing device and an interior cooling fan for cooling down the interior of the image forming apparatus. In this case, the operation statuses of the airflow generation members change in accordance with the operation status of the image forming apparatus (for example, the idling state or the image formation state). When the operation statuses of the airflow generation members change, the airflow generated by the airflow generation members in the image forming apparatus change, and consequently the temperature distribution of the fixing device in the axis direction change. As a result, the heating amount of a sheet at the fixing nip is varied in the axis direction of the fixing device, and fixation failure may be caused. During an idling state, in particular, the heat value required for maintaining the temperature of the fixing device is small in comparison with the image formation state, and therefore, the temperature distribution of the fixing device in the axis direction is significantly changed under the influence of the airflow generated by the airflow generation members.

It is to be noted that the technique disclosed in Japanese Patent Application Laid-Open No. 7-114294 is not designed to prevent fixation failure in the case where the operation status of a fan is changed, and therefore is not provided with no configuration for such a purpose.

### SUMMARY OF THE INVENTION

An object of the present invention is to provide an image forming apparatus, an image formation system and a heating control method which can prevent fixation failure in the case where the operation status of an airflow generation member is changed.

To achieve at least one of the abovementioned objects, an image forming apparatus of an embodiment of the present invention includes: a fixing member configured to heat a toner image on a sheet to fix the toner image; a heating section including a plurality of heating members configured to supply heat to the fixing member; a plurality of airflow generation members configured to generate airflows, the airflows being different from each other in influence on a temperature of the fixing member in an axis direction; a temperature detection section configured to detect the temperature of the fixing member; and a control section configured to control a heating amount of the heating section on a basis of the temperature detected by the temperature detection section and a target temperature of the fixing member, wherein the control section controls the heating amount of the heating section in accordance with operation statuses of the airflow generation members such that the temperature of the fixing member in the axis direction is uniform.

Desirably, in the image forming apparatus, the temperature detection section detects a temperature of one of end portions of the fixing member in the axis direction.

Desirably, in the image forming apparatus, the heating section includes a first heating member configured to heat one end portion of the fixing member in the axis direction to a temperature higher than that of the other end portion of the fixing member, and a second heating member configured to heat the other end portion to a temperature higher than that of the one end portion.

Desirably, in the image forming apparatus, the heating section includes a third heating member configured to heat a center portion of the fixing member in the axis direction to a temperature higher than those of the one end portion and the other end portion, the first heating member heats the one end portion to a temperature higher than those of the center portion and the other end portion, and the second heating member heats the other end portion to a temperature higher than those of the center portion and the one end portion.

Desirably, in the image forming apparatus, the first heating member heats a portion between the center portion and the one end portion of the fixing member in the axis direction to a temperature higher than that of a portion between the center portion and the other end portion of the fixing member in the axis direction, and the second heating member heats a portion between the center portion and the other end portion of the fixing member in the axis direction to a temperature higher than that of a portion between the center portion and the one end portion of the fixing member in the axis direction.

Desirably, in the image forming apparatus, the airflow generation members generate airflow that provides a gradient to a temperature distribution of the fixing member in the axis direction.

Desirably, in the image forming apparatus, the airflow generation members generate airflow that uniformizes a temperature distribution of the fixing member in the axis direction.

Desirably, in the image forming apparatus, the control section controls the heating amount of the heating section in accordance with the operation statuses of the airflow generation members and a temperature in the image forming apparatus.

Desirably, in the image forming apparatus, the control section controls the heating amount of the heating section in accordance with the operation statuses of the airflow generation members and an image formation status in the image forming apparatus.

Desirably, in the image forming apparatus, the control section determines the heating amount of the heating section in accordance with the operation statuses of the airflow generation members when the image forming apparatus is in an idling state.

An image formation system reflecting another aspect of an embodiment of the present invention includes a plurality of units including an image forming apparatus, the image formation system including: a fixing member configured to heat a toner image on a sheet to fix the toner image; a heating section including a plurality of heating members configured to supply heat to the fixing member; a plurality of airflow generation members configured to generate airflows, the airflows being different from each other in influence on a temperature of the fixing member in an axis direction; a temperature detection section configured to detect the temperature of the fixing member; and a control section configured to control a heating amount of the heating section on a basis of the temperature detected by the temperature detection section and a target temperature of the fixing member, wherein the control section controls the heating amount of the heating section in accordance with operation statuses of the airflow generation members such that the temperature of the fixing member in the axis direction is uniform.

Desirably, in the image formation system, the temperature detection section detects a temperature of one of end portions of the fixing member in the axis direction.

Desirably, in the image formation system, the heating section includes a first heating member configured to heat one end portion of the fixing member in the axis direction to a temperature higher than that of the other end portion of the fixing member, and a second heating member configured to heat the other end portion to a temperature higher than that of the one end portion.

Desirably, in the image formation system, the heating section includes a third heating member configured to heat a center portion of the fixing member in the axis direction to a temperature higher than those of the one end portion and the other end portion, the first heating member heats the one end portion to a temperature higher than those of the center portion and the other end portion, and the second heating member heats the other end portion to a temperature higher than those of the center portion and the one end portion.

Desirably, in the image formation system, the first heating member heats a portion between the center portion and the one end portion of the fixing member in the axis direction to a temperature higher than that of a portion between the center portion and the other end portion of the fixing member in the axis direction, and the second heating member heats a portion between the center portion and the other end portion of the fixing member in the axis direction to a temperature higher than that of a portion between the center portion and the one end portion of the fixing member in the axis direction.

Desirably, in the image formation system, the airflow generation members generate airflow that provides a gradient to a temperature distribution of the fixing member in the axis direction.

Desirably, in the image formation system, the airflow generation members generate airflow that uniformizes a temperature distribution of the fixing member in the axis direction.

Desirably, in the image formation system, the control section controls the heating amount of the heating section in accordance with the operation statuses of the airflow generation members and a temperature in the image forming apparatus.

Desirably, in the image formation system, the control section controls the heating amount of the heating section in accordance with the operation statuses of the airflow generation members and an image formation statuses in the image forming apparatus.

Desirably, in the image formation system, the control section determines the heating amount of the heating section in accordance with the operation statuses of the airflow generation members when the image forming apparatus is in an idling state.

A heating control method reflecting another aspect of an embodiment of the present invention in an image forming apparatus, the image forming apparatus including: a fixing member configured to heat a toner image on a sheet to fix the toner image; a heating section including a plurality of heating members configured to supply heat to the fixing member; a plurality of airflow generation members configured to generate airflows, the airflows being different from each other in influence on a temperature of the fixing member in an axis direction; a temperature detection section configured to detect the temperature of the fixing member; and a control section configured to control a heating amount of the heating section on a basis of the temperature detected by the temperature detection section and a target temperature of the fixing member, the heating control method including: controlling the heating amount of the heating section in accordance with operation statuses of the airflow generation members such that the temperature of the fixing member in the axis direction is uniform.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 schematically illustrates a general configuration of an image forming apparatus of an embodiment;

FIG. 2 illustrates a principal part of a control system of the image forming apparatus of the embodiment;

FIGS. 3A and 3B illustrate a configuration of a heater unit;

FIG. 4 illustrates a plurality of temperature detection sections provided to face a heating roller;

FIG. 5 illustrates airflow generated by operations of fans in image forming apparatus;

FIGS. 6A and 6B show a temperature distribution of a fixing belt in the axis direction during idling and during image formation;

FIG. 7 is a flowchart of a heating control operation of the image forming apparatus of the embodiment;

FIGS. 8A and 8B are timing diagrams showing timings of turning on and off of a plurality of heaters provided in the heater unit;

FIGS. 9A and 9B illustrate a modification of the configuration of the heater unit; and

FIGS. 10A and 10B illustrate a modification of the configuration of the heater unit.

### DESCRIPTION OF THE PREFERRED EMBODIMENTS

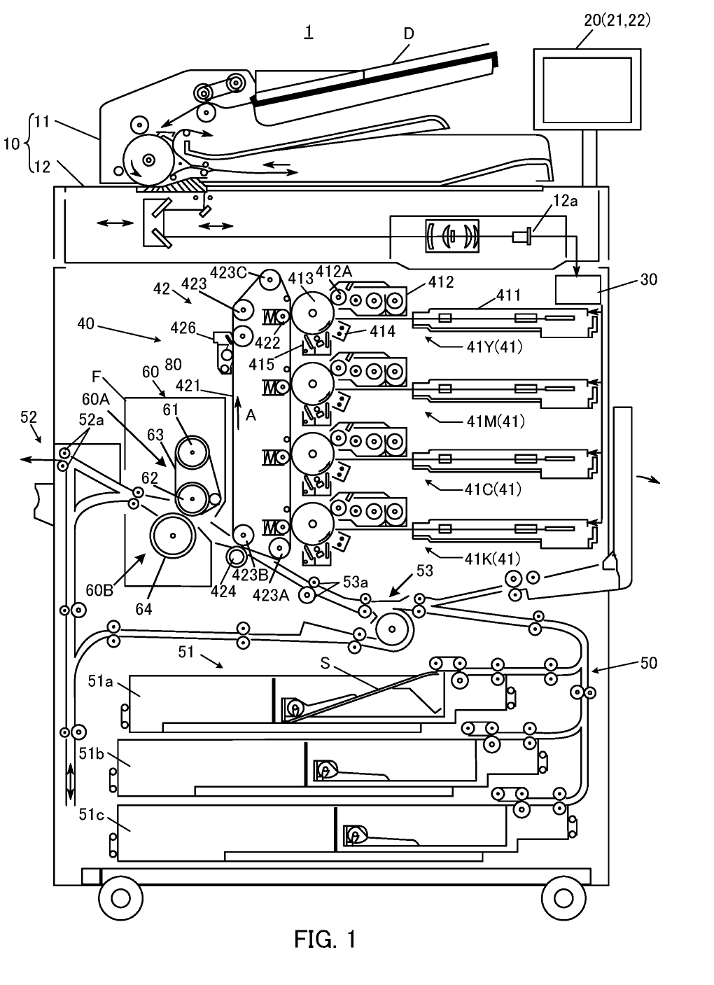

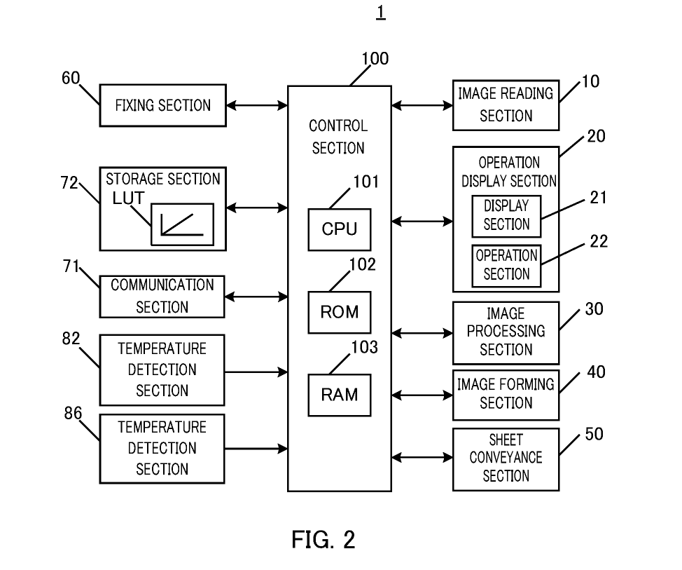

In the following, the present embodiment is described in detail with reference to the drawings. FIG. 1 illustrates an overall configuration of image forming apparatus 1 according to the embodiment of the present invention. FIG. 2 illustrates a principal part of a control system of image forming apparatus 1 according to the embodiment. Image forming apparatus 1 illustrated in FIGS. 1 and 2 is a color image forming apparatus of an intermediate transfer system using electrophotographic process technology. That is, image forming apparatus 1 transfers (primary-transfers) toner images of yellow (Y), magenta (M), cyan (C), and black (K) formed on photoconductor drums 413 to intermediate transfer belt 421, and superimposes the toner images of the four colors on one another on intermediate transfer belt 421. Then, image forming apparatus 1 transfers (secondary-transfers) the resultant image to sheet S, to thereby form an image.

A longitudinal tandem system is adopted for image forming apparatus 1. In the longitudinal tandem system, respective photoconductor drums 413 corresponding to the four colors of YMCK are placed in series in the travelling direction (vertical direction) of intermediate transfer belt 421, and the toner images of the four colors are sequentially transferred to intermediate transfer belt 421 in one cycle.

As illustrated in FIG. 2, image forming apparatus 1 includes image reading section 10, operation display section 20, image processing section 30, image forming section 40, sheet conveyance section 50, fixing section 60 and control section 100.

Control section 100 includes central processing unit (CPU) 101, read only memory (ROM) 102, random access memory (RAM) 103 and the like. CPU 101 reads a program suited to processing contents out of ROM 102, develops the program in RAM 103, and integrally controls an operation of each block of image forming apparatus 1 in cooperation with the developed program. At this time, CPU 101 refers to various kinds of data stored in storage section 72. Storage section 72 is composed of, for example, a non-volatile semiconductor memory (so-called flash memory) or a hard disk drive.

Control section 100 transmits and receives various data to and from an external apparatus (for example, a personal computer) connected to a communication network such as a local area network (LAN) or a wide area network (WAN), through communication section 71. Control section 100 receives, for example, image data transmitted from the external apparatus, and performs control to form an image on sheet S on the basis of the image data (input image data). Communication section 71 is composed of, for example, a communication control card such as a LAN card.

Image reading section 10 includes auto document feeder (ADF) 11, document image scanning device 12 (scanner), and the like.

Auto document feeder 11 causes a conveyance mechanism to feed document D placed on a document tray, and sends out document D to document image scanner 12. Auto document feeder 11 enables images (even both sides thereof) of a large number of documents D placed on the document tray to be successively read at once.

Document image scanner 12 optically scans a document fed from auto document feeder 11 to its contact glass or a document placed on its contact glass, and brings light reflected from the document into an image on the light receiving surface of charge coupled device (CCD) sensor 12a, to thereby read the document image. Image reading section 10 generates input image data on the basis of a reading result provided by document image scanner 12. Image processing section 30 performs predetermined image processing on the input image data.

Operation display section 20 includes, for example, a liquid crystal display (LCD) with a touch panel, and functions as display section 21 and operation section 22. Display section 21 displays various operation screens, image conditions, operating statuses of functions, and the like in accordance with display control signals received from control section 100. Operation section 22 includes various operation keys such as numeric keys and a start key, receives various input operations performed by a user, and outputs operation signals to control section 100.

Image processing section 30 includes a circuit that performs a digital image process suited to initial settings or user settings on the input image data, and the like. For example, image processing section 30 performs tone correction on the basis of tone correction data (tone correction table), under the control of control section 100. In addition to the tone correction, image processing section 30 also performs various correction processes such as color correction and shading correction as well as a compression process, on the input image data. Image forming section 40 is controlled on the basis of the image data that has been subjected to these processes.

Image forming section 40 includes: image forming units 41Y, 41M, 41C, and 41K that form images of colored toners of a Y component, an M component, a C component, and a K component on the basis of the input image data; intermediate transfer unit 42; and the like.

Image forming units 41Y, 41M, 41C, and 41K for the Y component, the M component, the C component, and the K component have similar configurations. For ease of illustration and description, common elements are denoted by the same reference signs. Only when elements need to be discriminated from one another, Y, M, C, or K is added to their reference signs. In FIG. 1, reference signs are given to only the elements of image forming unit 41Y for the Y component, and reference signs are omitted for the elements of other image forming units 41M, 41C, and 41K.

Image forming unit 41 includes exposing device 411, developing device 412, photoconductor drum 413, charging device 414, drum cleaning device 415 and the like.

Photoconductor drum 413 is, for example, a negative-charge-type organic photoconductor (OPC) formed by sequentially laminating an under coat layer (UCL), a charge generation layer (CGL), and a charge transport layer (CTL) on the circumferential surface of a conductive cylindrical body (aluminum-elementary tube) which is made of aluminum and has a diameter of 60 mm. The charge generation layer is made of an organic semiconductor in which a charge generating material (for example, phthalocyanine pigment) is dispersed in a resin binder (for example, polycarbonate), and generates a pair of positive charge and negative charge through light exposure by exposure device 411. The charge transport layer is made of a layer in which a hole transport material (electron-donating nitrogen compound) is dispersed in a resin binder (for example, polycarbonate resin), and transports the positive charge generated in the charge generation layer to the surface of the charge transport layer.

Control section 100 controls a driving current supplied to a driving motor (not shown in the drawings) that rotates photoconductor drums 413, whereby photoconductor drums 413 is rotated at a constant circumferential speed.

Charging device 414 causes corona discharge to evenly negatively charge the surface of photoconductor drum 413 having photoconductivity.

Exposure device 411 is composed of, for example, a semiconductor laser, and configured to irradiate photoconductor drum 413 with laser light corresponding to the image of each color component. The positive charge is generated in the charge generation layer of photoconductor drum 413 and is transported to the surface of the charge transport layer, whereby the surface charge (negative charge) of photoconductor drum 413 is neutralized. An electrostatic latent image of each color component is formed on the surface of photoconductor drum 413 by the potential difference from its surroundings.

Developing device 412 is a developing device of a two-component reverse type, and attaches toners of respective color components to the surface of photoconductor drums 413, and visualizes the electrostatic latent image to form a toner image.

Drum cleaning device 415 includes a drum cleaning blade that is brought into sliding contact with the surface of photoconductor drum 413, and removes residual toner that remains on the surface of photoconductor drum 413 after the primary transfer.

Intermediate transfer unit 42 includes intermediate transfer belt 421, primary transfer roller 422, a plurality of support rollers 423, secondary transfer roller 424, belt cleaning device 426 and the like.

Intermediate transfer belt 421 is composed of an endless belt using PI (polyimide) as a base, and is stretched around a plurality of support rollers 423 including steering roller 423C in a loop form. At least one of the plurality of support rollers 423 is composed of a driving roller, and the others are each composed of a driven roller. Preferably, for example, roller 423A disposed on the downstream side in the belt travelling direction relative to primary transfer rollers 422 for K-component is a driving roller. With this configuration, the travelling speed of the belt at a primary transfer section can be easily maintained at a constant speed. When driving roller 423A rotates, intermediate transfer belt 421 travels in arrow A direction at a constant speed.

Intermediate transfer belt 421 is a belt having conductivity and elasticity which includes on the surface thereof a high resistance layer having a volume resistivity of 8 to 11 log Ω·cm, for example. Intermediate transfer belt 421 is rotationally driven by a control signal from control section 100. It is to be noted that the material, thickness and hardness of intermediate transfer belt 421 are not limited as long as intermediate transfer belt 421 has conductivity and elasticity.

Primary transfer rollers 422 are disposed on the inner periphery side of intermediate transfer belt 421 to face photoconductor drums 413 of respective color components. Primary transfer rollers 422 are brought into pressure contact with photoconductor drums 413 with intermediate transfer belt 421 therebetween, whereby a primary transfer nip for transferring a toner image from photoconductor drums 413 to intermediate transfer belt 421 is formed.

When intermediate transfer belt 421 passes through the primary transfer nip, the toner images on photoconductor drums 413 are sequentially primary-transferred to intermediate transfer belt 421. To be more specific, a primary transfer bias is applied to primary transfer rollers 422, and an electric charge of the polarity opposite to the polarity of the toner is applied to the rear side (the side that makes contact with primary transfer rollers 422) of intermediate transfer belt 421, whereby the toner image is electrostatically transferred to intermediate transfer belt 421.

Secondary transfer roller 424 is disposed to face roller 423B (hereinafter referred to as “backup roller 423B”) disposed on the downstream side in the belt travelling direction relative to driving roller 423A, on the outer peripheral surface side of intermediate transfer belt 421. Secondary transfer roller 424 is brought into pressure contact with backup roller 423B with intermediate transfer belt 421 therebetween, whereby a secondary transfer nip for transferring a toner image from intermediate transfer belt 421 to sheet S is formed.

When sheet S passes through the secondary transfer nip, the toner image on intermediate transfer belt 421 is secondary-transferred to sheet S. To be more specific, a secondary transfer bias is applied to secondary transfer roller 424, and an electric charge of the polarity opposite to the polarity of the toner is applied to the rear side (the side that makes contact with secondary transfer roller 424) of sheet S, whereby the toner image is electrostatically transferred to sheet S. Sheet S on which the toner images have been transferred is conveyed toward fixing section 60.

Belt cleaning device 426 removes transfer residual toner which remains on the surface of intermediate transfer belt 421 after a secondary transfer. A configuration (so-called belt-type secondary transfer unit) in which a secondary transfer belt is installed in a stretched state in a loop form around a plurality of support rollers including a secondary transfer roller may also be adopted in place of secondary transfer roller 424.

At the fixing nip, fixing section 60 applies heat and pressure to sheet S on which a toner image has been secondary-transferred to fix the toner image on sheet S. Fixing section 60 is disposed as a unit in fixing part F.

Sheet conveyance section 50 includes sheet feeding section 51, sheet ejection section 52, conveyance path section 53 and the like. Three sheet feed tray units 51a to 51c included in sheet feeding section 51 store sheets S (standard sheets, special sheets) discriminated on the basis of the basis weight, the size, and the like, for each type set in advance. Conveyance path section 53 includes a plurality of pairs of conveyance rollers such as a pair of registration rollers 53a.

Sheets S stored in sheet tray units 51a to 51c are output one by one from the uppermost, and conveyed to image forming section 40 by conveyance path section 53. At this time, the registration roller section in which the pair of registration rollers 53a are arranged corrects skew of sheet S fed thereto, and the conveyance timing is adjusted. Then, in image forming section 40, the toner image on intermediate transfer belt 421 is secondary-transferred to one side of sheet S at one time, and a fixing process is performed in fixing section 60. Sheet S on which an image has been formed is ejected out of the image forming apparatus by sheet ejection section 52 including sheet ejection rollers 52a.

Next, a detailed configuration of fixing section 60 is described with reference to FIG. 1. Fixing section 60 includes upper fixing section 60A disposed on the fixing surface (toner image formed surface) side of sheet S, and lower fixing section 60B disposed on the rear surface (the surface on the side opposite to the fixing surface) side of sheet S.

Upper fixing section 60A includes heating roller 61 and fixing roller 62. Endless fixing belt 63 is wound around heating roller 61 and fixing roller 62 with a predetermined belt tensile force (for example, 250N) in a stretched state.

Lower fixing section 60B includes pressure roller 64. Pressure roller 64 is pressed against fixing roller 62 with a predetermined fixing load (for example, 2500N) with fixing belt 63 therebetween. In this manner, a fixing nip for conveying sheet S in a tightly sandwiching manner is formed between fixing roller 62 and pressure roller 64. Fixing roller 62 and fixing belt 63 function as a “fixing member” of the embodiment of the present invention.

Fixing belt 63 makes contact with sheet S on which a toner image has been formed to heat the sheet S at a fixing temperature (160 to 200° C., for example). The fixing temperature is a temperature at which a heat energy required for melting the toner on sheet S can be obtained, and the fixing temperature differs depending on factors such as the type of sheet S on which an image is to be formed.

For fixing belt 63, for example, a PI (polyimide) resin having a thickness of 70 μm is used as a base, and the outer peripheral surface of the base is covered with a heat-resistant silicon rubber (JIS-A hardness: 30°) having a thickness of 200 μm as an elastic layer. Further, the surface layer has a coating of a PFA (perfluoro alkoxy) resin, which is a heat-resistant resin, having a thickness of 30 μm.

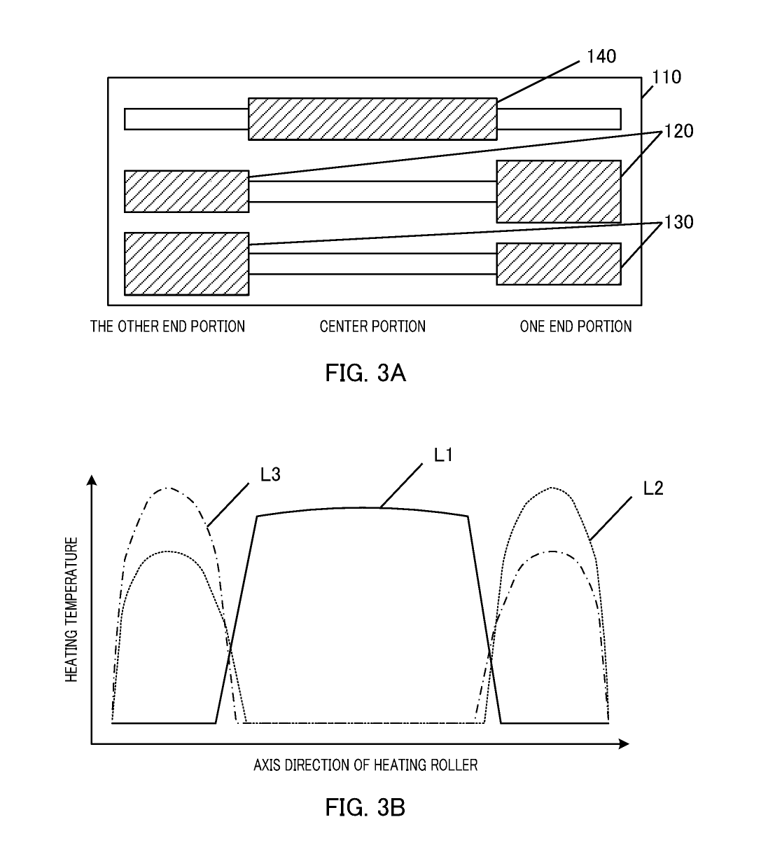

Heating roller 61 heats fixing belt 63. In heating roller 61, heater unit 110 serving as a heating section for heating fixing belt 63 is provided (see FIG. 3A). Heating roller 61 is a cylindrical mandrel formed of a metal or the like, or a cylindrical mandrel formed of a metal or the like whose outer peripheral surface is coated with a fluorine resin or the like, for example. Heating roller 61 is driven into rotation when the power is transmitted thereto from a driving device not illustrated (for example, a motor). Fixing belt 63 is driven into rotation along with the rotation of heating roller 61.

To deal with various sheet widths of sheets S passing through the fixing nip, heater unit 110 includes rod-shaped first heater 120 (which corresponds to “first heating member” of the embodiment of the present invention), second heater 130 (which corresponds to “second heating member” of the embodiment of the present invention) and third heater 140 (which corresponds to “third heating member” of the embodiment of the present invention).

FIG. 3A illustrates heater unit 110 as viewed in a direction orthogonal to the longitudinal direction of heater unit 110 (which corresponds to the axis direction of heating roller 61). Each of first heater 120, second heater 130 and third heater 140 is a lamp including a tubular valve and a filament extended in the valve along the axis direction.

Third heater 140 is a main heater lamp whose center portion in the axis direction is formed to generate heat. That is, third heater 140 heats a center portion in the axis direction of heating roller 61, and in turn, fixing belt 63 to a temperature higher than that of one end portion and the other end portion thereof. As indicated with solid line L1 in FIG. 3B, third heater 140 has a heating temperature distribution in which the center portion has a temperature higher than that of the left and right end portions, and the left and right end portions and the center portion are connected by a predetermined temperature gradient. The length of the center portion of third heater 140 in the axis direction corresponds to the width of a longitudinal-feed A4 sheet, for example.

First heater 120 is a sub heater lamp whose both end portions in the axis direction are formed to generate heat. First heater 120 is configured to heat one end portion of heating roller 61, and in turn, fixing belt 63 in the axis direction to a temperature higher than the other end portion thereof. That is, as indicated with dotted line L2 in FIG. 3B, first heater 120 has a heating temperature distribution in which the right end portion has a temperature higher than that of the left end portion, and the left and right end portions and the center portion are connected by a predetermined temperature gradient.

Second heater 130 is a sub heater lamp whose both end portions in the axis direction are formed to generate heat. Second heater 130 is configured to heat the other end portion of heating roller 61, and in turn, fixing belt 63 in the axis direction to a temperature higher than that of one end portion thereof. That is, as indicated with dashed line L3 in FIG. 3B, second heater 130 has a heating temperature distribution in which the left end portion has a temperature higher than that of the right end portion, and the left and right end portions and the center portion are connected by a predetermined temperature gradient. In the present embodiment, first heater 120 and second heater 130 have a bilaterally symmetric temperature distribution (temperature gradient) in the axis direction of heating roller 61. Alternatively, first heater 120 and second heater 130 may have a bilaterally asymmetric temperature distribution in the axis direction of heating roller 61.

The sum of the length of the filament arranged at a center portion of third heater 140 in the axis direction and lengths of the filaments arranged at the both end portions of first heater 120 and second heater 130 in the axis direction corresponds to the width of a large sheet such as an A4 sheet, for example.

First heater 120, second heater 130 and third heater 140 selectively turn on (generate heat) or turn off (generate no heat) in accordance with a command output from control section 100.

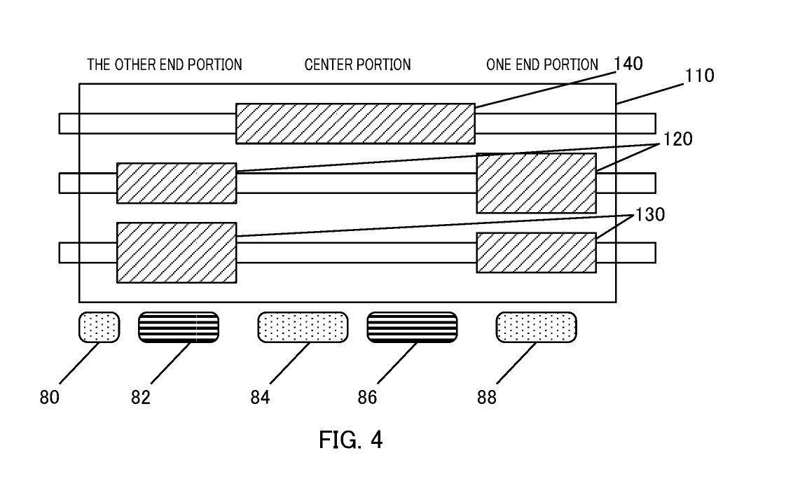

FIG. 4 illustrates a plurality of temperature detection sections 80, 82, 84, 86 and 88 which are provided to face heating roller 61, and in turn, heater unit 110. As illustrated in FIG. 4, temperature detection section 80 for detecting abnormality at an end portion, temperature detection section 82 for controlling the temperature of an end portion, temperature detection section 84 for detecting abnormality at a center portion, temperature detection section 86 for controlling the temperature of the center portion and temperature detection section 88 for detecting abnormality at an end portion are disposed in this order along the longitudinal direction of heater unit 110.

Temperature detection section 80 detects the temperature of the other end portion of heating roller 61 in the axis direction and outputs the temperature to control section 100. On the basis of the temperature output from detection section 80, control section 100 monitors whether the temperature of the other end portion of heating roller 61 in the axis direction has an abnormal value. When this temperature has an abnormal value during the image formation process, control section 100 stops the image formation process under execution.

Temperature detection section 82 detects the temperature of the other end portion of heating roller 61 in the axis direction and outputs the temperature to control section 100. For example, on the basis of the difference between the temperature output from detection section 82 and a target temperature of the other end portion of heating roller 61, and in turn, fixing belt 63 in the axis direction, control section 100 turns on or off first and second heaters 120 and 130 such that the temperature changes toward the target temperature.

Temperature detection section 84 detects the temperature of a center portion of heating roller 61 in the axis direction and outputs the temperature to control section 100. On the basis of the temperature output from temperature detection section 84, control section 100 monitors whether the temperature of a center portion of heating roller 61 in the axis direction has an abnormal value. When the temperature has an abnormal value during the image formation process, control section 100 stops the image formation process under execution.

Temperature detection section 86 detects the temperature of a center portion of heating roller 61 in the axis direction and outputs the temperature to control section 100. For example, on the basis of the difference between the temperature output from temperature detection section 86 and a target temperature of a center portion of heating roller 61, and in turn, fixing belt 63 in the axis direction, control section 100 turns of or off third heater 140 such that the temperature is changed toward the target temperature.

Temperature detection section 88 detects the temperature of one end portion of heating roller 61 in the axis direction and outputs the temperature to control section 100. On the basis of the temperature output from temperature detection section 88, control section 100 monitors whether the temperature of one end portion of heating roller 61 in the axis direction has an abnormal value. When the temperature has an abnormal value during the image formation process, control section 100 stops the image formation process under execution.

To prevent fixation failure, control section 100 turns of or off first heater 120, second heater 130 and third heater 140 such that the amount of heating of sheet S at the fixing nip is uniform in the axis direction of fixing belt 63.

Ideally, a temperature detection section for temperature control and a temperature detection section for abnormality detection are disposed for each of one end portion, the center portion and the other end portion of heating roller 61 in the axis direction. However, in the present embodiment, installation places for the temperature detection sections are limited, and therefore it is difficult to dispose a temperature detection section for temperature control for each one end portion and the other end portion of heating roller 61 in the axis direction. For example, in the case where the heat generation width of heating roller 61 in the axis direction of heating roller 61 is 330 mm, the width of the temperature detection section for temperature control is required to be approximately 50 mm, the width of the temperature detection section for abnormality detection is required to be 50 mm, and the width of a line that connects the temperature detection section with a power source that supplies power to the temperature detection section is required to be 30 mm That is, a width of 130 mm is required for one set of the temperature detection section for temperature control and the temperature detection section for abnormality detection, and therefore two sets of the temperature detection sections (width of 260 mm) can be disposed, but three sets of the temperature detection sections (width of 390 mm), which are required in the present embodiment, cannot be disposed.

In view of this, the temperature detection section for temperature control is disposed at a position corresponding to only one of one end portion and the other end portion of heating roller 61 in the axis direction (in the present embodiment, the other end portion), control section 100 estimates the temperature of the one end portion side (the side where the temperature detection section for temperature control cannot be disposed) from a detection result of the temperature detection section to perform the turning operation of first and second heaters 120 and 130. One reason for this is to uniformize the temperature distribution of the fixing nip in the axis direction.

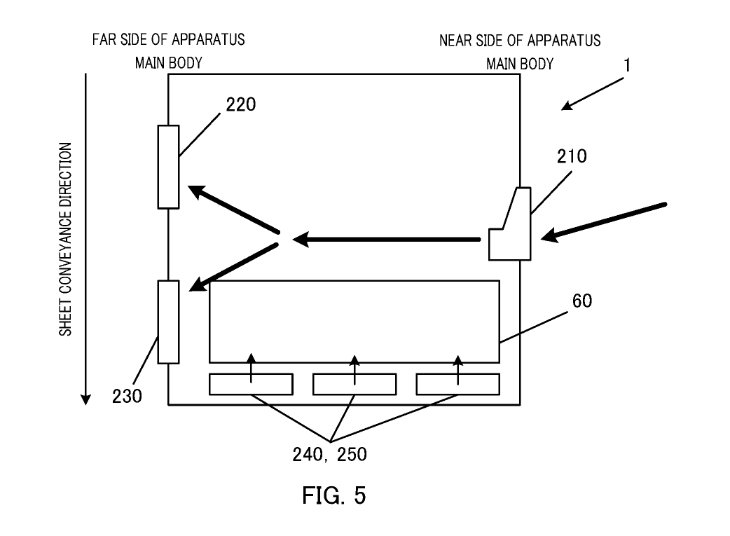

Next, with reference to FIG. 5, airflow in image forming apparatus 1 which is generated with a plurality of fans provided in image forming apparatus 1 is described. In image forming apparatus 1, typically, an airflow structure is provided in which air is sucked from the near side (front surface) of the apparatus main body with suction duct 210 and ejected to the depth side (back surface) of the apparatus main body as indicated with the heavy arrow in FIG. 5 for the purpose of ejection and distribution of heat in the apparatus body.

For example, during the image formation process, the value of the heat generated by fixing section 60 is large and the temperature in image forming apparatus 1 is high, and therefore it is necessary to operate apparatus interior cooling fan 220 and fixation exhaust fan 230 disposed on the depth side of the apparatus main body at 100% output. On the other hand, during the idling state, the value of the heat generated by fixing section 60 is small, and therefore it is possible to prevent temperature rise in image forming apparatus 1 by operating apparatus interior cooling fan 220 and fixation exhaust fan 230 at about 30% output.

It is to be noted that, in the idling state immediately after the completion of the image formation process, the heat generated during the image formation process still remains in image forming apparatus 1, and therefore, in some situations, apparatus interior cooling fan 220 and fixation exhaust fan 230 are operated at 100% output for a certain period, or operated at an output greater than that of the idling state (for example, at 50%).

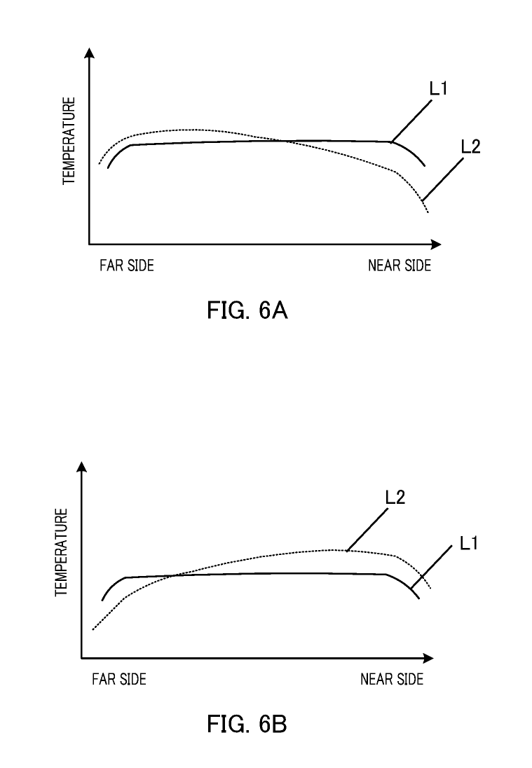

FIG. 6A shows a temperature distribution of fixing belt 63 in the axis direction in the idling state. In the idling state, the temperature of the fixing nip can be maintained with a small power, and the amount of the supply of heat by first heater 120, second heater 130 and third heater 140 is small. Since the operation of apparatus interior cooling fan 220 and fixation exhaust fan 230 is maintained, however, the outside air having a low temperature enters the apparatus from suction duct 210, and the air heated by the heat generated by fixing section 60 flows through the apparatus main body on the depth side, thus reducing the temperature of the near side of the apparatus main body (see the dotted line L2 of FIG. 6A). That is, the inclination of the temperature is increased such that the temperature of the near side is lower than the temperature of the depth side. Accordingly, by prolonging the operating period of a heater (in the present embodiment, first heater 120) whose heating value on the near side of the apparatus main body is large in comparison with the operating period of a heater (in the present embodiment, second heater 130) whose heating value is small, the temperature distribution of the fixing nip in the axis direction can be uniformized to prevent fixation failure (see solid line L1 in FIG. 6A).

FIG. 6B shows a temperature distribution of fixing belt 63 in the axis direction during the image formation. When the operating period of first heater 120 is set to a large value as in the idling state during which the temperature drop is large on the near side as illustrated in FIG. 6A in the image formation process during which large power is required for maintaining the temperature of the fixing nip, the temperature of the near side is excessively increased (see dotted line L2 of FIG. 6B). In this case, by prolonging the operating period of second heater 130 whose heating value on the near side is small in comparison with the idling state, the temperature distribution of the fixing nip in the axis direction can be uniformized to prevent fixation failure (see solid line L1 in FIG. 6B).

Further, in the present embodiment, separation fan 240 that applies air to sheet S having passed through the fixing nip so as to separate sheet S from fixing belt 63 is installed at fixing section 60 as illustrated in FIG. 5. In addition, pressure roller cooling fan 250 that applies air to pressure roller 64 to cool down pressure roller 64 is installed. With the operations of the fans, airflow that acts to uniformize the temperature distribution of the fixing nip in the axis direction is generated (see the thin arrow of FIG. 5).

Incidentally, along with the change of the operation state (for example, the idling state, the image formation state and the like) of image forming apparatus 1, not only the heat supplying amount of first heater 120, second heater 130 and third heater 140, but also the operation statuses of the above-mentioned fans are changed. When the operation statuses of the fans are changed, the airflow generated by the fans in image forming apparatus 1 is changed, and the temperature distribution of the fixing nip in the axis direction is influenced by the change. As a result, the heating amount of sheet S at the fixing nip varies in the axis direction of the fixing nip, and fixation failure is caused. During the idling state, in particular, the heat value required for maintaining the temperature of fixing section 60 is small in comparison with the image formation, and therefore the temperature distribution of the fixing nip in the axis direction is significantly changed under the influence of the airflow generated by the fans.

In view of this, in the present embodiment, control section 100 controls the heating amount of first heater 120 and second heater 130 such that the temperature of fixing belt 63, and in turn, the fixing nip in the axis direction is uniform in accordance with the change of the operation status of the fan provided in image forming apparatus 1.

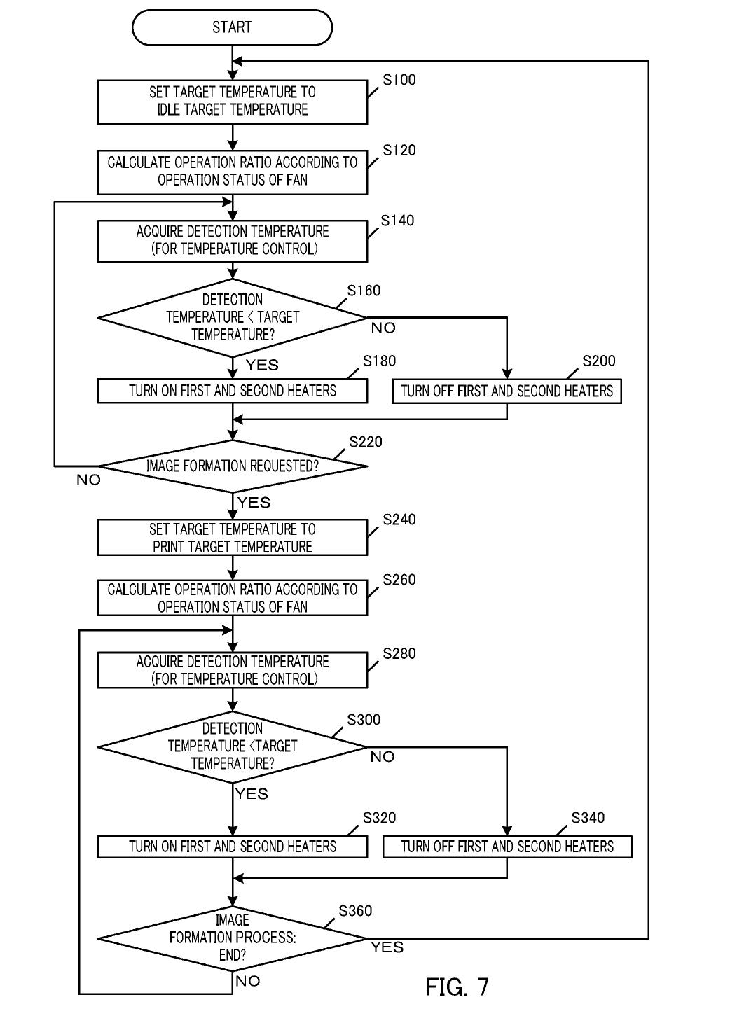

Next, with reference to the flowchart of FIG. 7, a heating control operation of image forming apparatus 1 is described. Step S100 in FIG. 7 is started when the power of image forming apparatus 1 in an off state is turned on, for example.

First, control section 100 sets the target temperature of fixing belt 63 to an idle target temperature which is preliminarily set as the target temperature of the idling state (step S100). Next, control section 100 calculates the operation ratio of first heater 120 and second heater 130 in accordance with the operation status of the fan provided in image forming apparatus 1 in the idling state (step S120). In the present embodiment, the operation ratio of first heater 120 and second heater 130 is defined as the following Expressions (1) and (2).

operation ratio (%) of first heater 120=operating period of first heater 120/(operating period of first heater 120+operating period of second heater 130) (1)

operation ratio (%) of second heater 130=100%−operation ratio (%) of first heater 120 (2)

The operation ratio of first heater 120 is calculated from the product of the driving state of each fan (operation output: 0 to 100%) multiplied by a coefficient indicating the degree of the influence on the temperature distribution of the fixing nip in the axis direction. The coefficient of the fan having a large influence on the temperature distribution is set to a large value, and the coefficient of the fan having a small influence is set to a small value, and thus, the operation of the fan can be appropriately reflected in the operation ratio. It is to be noted that, since the influence of the fans on the temperature distribution differ depending on the airflow generated in the apparatus main body and the heat insulating state of fixing section 60, the above-mentioned coefficients differ depending on image forming apparatuses.

The following Expression (3) is an exemplary expression for calculating the operation ratio of first heater 120.

operation ratio (%) of first heater 120=50%+operation output of apparatus interior cooling fan 220×coefficient 1+operation output of separation fan 240×coefficient 2 (3)

Here, since coefficient 1 is a coefficient for apparatus interior cooling fan 220 which is a fan that reduces the temperature of the near side of the apparatus main body, coefficient 1 is required to increase the operation ratio of first heater 120 configured to heat the near side to the temperature higher than that of the far side, and therefore has a positive value. Meanwhile, since coefficient 2 is a coefficient for separation fan 240 which is a fan configured to uniformly reduce the temperature of the region from the near side to the far side of the apparatus main body, coefficient 2 is required to reduce the operation ratio of first heater 120, and therefore has a negative value.

Table 1 shows a relationship between the coefficients used for calculating the operation ratio of first heater 120 for the fans, and the operation outputs of the fans in accordance with the operation state of image forming apparatus 1. Table 1 also shows results of calculation of the operation ratio of first and second heaters 120 and 130 by Expression (3). As shown in Table 1, when the operation ratio is determined based on the operation statuses of apparatus interior cooling fan 220 and separation fan 240, the operation ratio of first heater 120 during the idling state is 68%, which is higher than the operation ratio (32%) of second heater 130 during the idling state. In addition, during the image formation process, the operation ratio of first heater 120 is 47%, which is slightly lower than the operation ratio (53%) of second heater 130. In Expression (3), it is also possible to calculate the operation ratio of first heater 120 by changing coefficients 1 and 2 in accordance with the change of the operation state of image forming apparatus 1 without changing the operation output of the fans. That is, the change of the operation status of the fans in accordance with the change of the operation state of image forming apparatus 1 may be reflected in coefficients 1 and 2.

TABLE 1

Operation output

| | | Idling | Image formation |
|---|---|---|---|
| | Coefficient | state | state |
| Apparatus interior | +0.6 | 30% | 100% |
| cooling fan | | | |
| Separation fan | −0.7 | 0% | 90% |

| | | |
|---|---|---|
| Operation ratio of first heater | 68% | 47% |
| Operation ratio of second heater | 32% | 53% |

Returning back to the flowchart of FIG. 7, control section 100 acquires a temperature (detection temperature) detected from temperature detection section 82 for controlling the temperature of an end portion at step S140. Next, control section 100 determines whether the acquired detection temperature is lower than the target temperature set at step S100 (step S160). When it is determined that the detection temperature is lower than the target temperature (step S160, YES), control section 100 turns on first heater 120 and second heater 130 for a predetermined period on the basis of the operation ratio calculated at step S120 (step S180). Thereafter, the process is advanced to step S220.

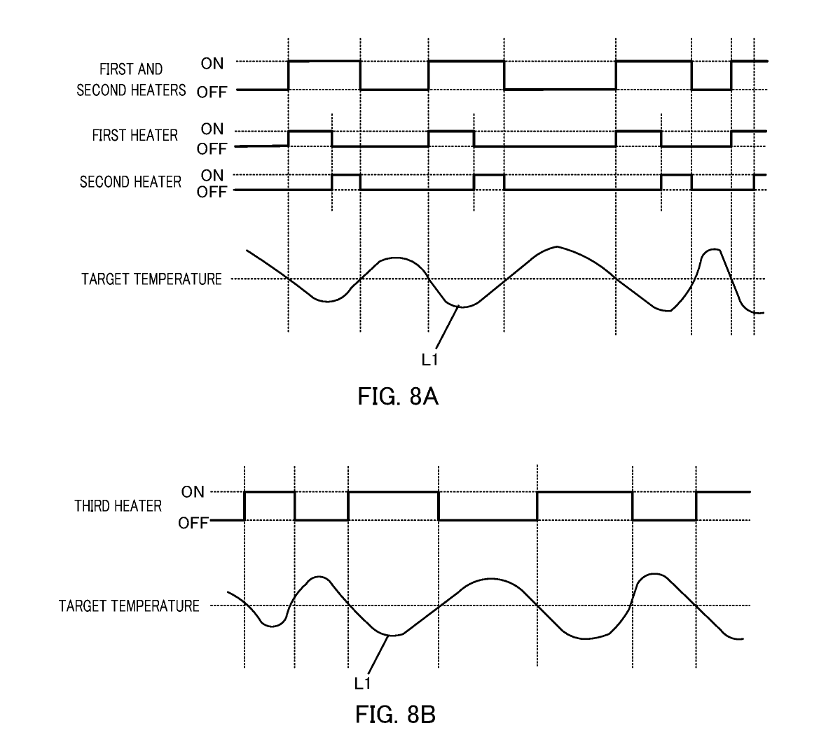

FIG. 8A is a timing diagram of first heater 120 and second heater 130 which are turned on or off in accordance with the detection temperature indicated with solid line L1. As illustrated in FIG. 8A, first, during a predetermined period in which first heater 120 and second heater 130 are turned on, control section 100 turns on first heater 120 and turns off second heater 130 for a period corresponding to the operation ratio of first heater 120. Next, first heater 120 is turned off and second heater 130 is turned on for a period corresponding to the operation ratio of second heater 130. It is to be noted that control section 100 may determine the periods during which first heater 120 and second heater 130 are turned on or off by dividing, in accordance with the calculated operation ratio, a period corresponding to a power supply cycle (for example, 60 Hz) of an AC power that supplies power to first heater 120 and second heater 130.

FIG. 8B is a timing diagram of third heater 140 which is turned on or off in accordance with the detection temperature of temperature detection section 86 (for controlling the temperature of the center portion) indicated with solid line L1. When the detection temperature is lower than the target temperature, control section 100 turns on third heater 140 for a predetermined period.

On the other hand, when the detection temperature is not lower than the target temperature (step S160, NO), control section 100 turns off first heater 120 and second heater 130 for a predetermined period (step S200). Thereafter, the process is advanced to step S220.

At step S220, control section 100 determines whether a request mage formation by a user operation at operation section 22 is received. When it is determined that image formation is not requested (step S220, NO), the process is returned to step S140. On the other hand, when it is determined that image formation is requested (step S220, YES), control section 100 sets the target temperature of fixing belt 63 to a print target temperature which is preliminarily set as the target temperature during the image formation process (step S240). Then, control section 100 controls image forming section 40 to start the image formation process.

Next, control section 100 calculates the operation ratio of first heater 120 and second heater 130 in accordance with the operation status of the fan provided in image forming apparatus 1 during the image formation process (step S260). As described above with reference to Table 1, control section 100 calculates the operation ratios of first heater 120 and second heater 130 as 47% and 53%, respectively, in the present embodiment.

Next, control section 100 acquires a temperature (detection temperature) detected from temperature detection section 82 for controlling the temperature of an end portion (step S280). Next, control section 100 determines whether the acquired detection temperature is lower than the target temperature set at step S240 (step S300). When it is determined that the detection temperature is lower than the target temperature (step S300, YES), control section 100 turns on first heater 120 and second heater 130 on the basis of the operation ratio calculated at step S260 for a predetermined period (step S320). Thereafter, the process is advanced to step S360.

On the other hand, when the detection temperature is not lower than the target temperature (step S300, NO), control section 100 turns off first heater 120 and second heater 130 for a predetermined period (step S340). Thereafter, the process is advanced to step S360.

At step S360, control section 100 determines whether the image formation process under execution is completed (step S360). When it is determined that the image formation process is not completed (step S360, NO), the process is returned to step S280. On the other hand, when it is determined that the image formation process is completed (step S360, YES), the operation state of image forming apparatus 1 is transferred from the image formation process to the idling, and therefore the process is returned to step S100.

As has been described in detail, in the present embodiment, image forming apparatus 1 includes fixing members (fixing roller 62, fixing belt 63) configured to heat a toner image on sheet S to fix the toner image; a heating section (heating roller 61) including a first heating member (first heater 120) configured to heat one end portion of the fixing member in the axis direction to a temperature higher than that of the other end portion and a second heating member (second heater 130) configured to heat the other end portion to a temperature higher than that of the one end portion; a plurality of airflow generation members (fans 220 to 250) configured to generate airflows, the airflows being different from each other in influence on a temperature of the fixing member in an axis direction; a temperature detection section configured to detect the temperature of the fixing member; temperature detection section 82 configured to detect the temperature of the fixing member; and control section 100 configured to control a heating amount of the heating section on a basis of the temperature detected by the temperature detection section and a target temperature of the fixing member. Control section 100 controls the heating amount of the heating section in accordance with operation statuses of the airflow generation members such that the temperature of the fixing member in the axis direction is uniform.

According to the above-mentioned configuration of the present embodiment, the heating amount of the first and second heating members is changed such that the temperature of the fixing member in the axis direction is uniform in accordance with the change of the operation status of fans 220 to 250 provided in image forming apparatus 1, and thus the heating amount of sheet S is uniformized in the axis direction of the fixing member, and fixation failure can be prevented.

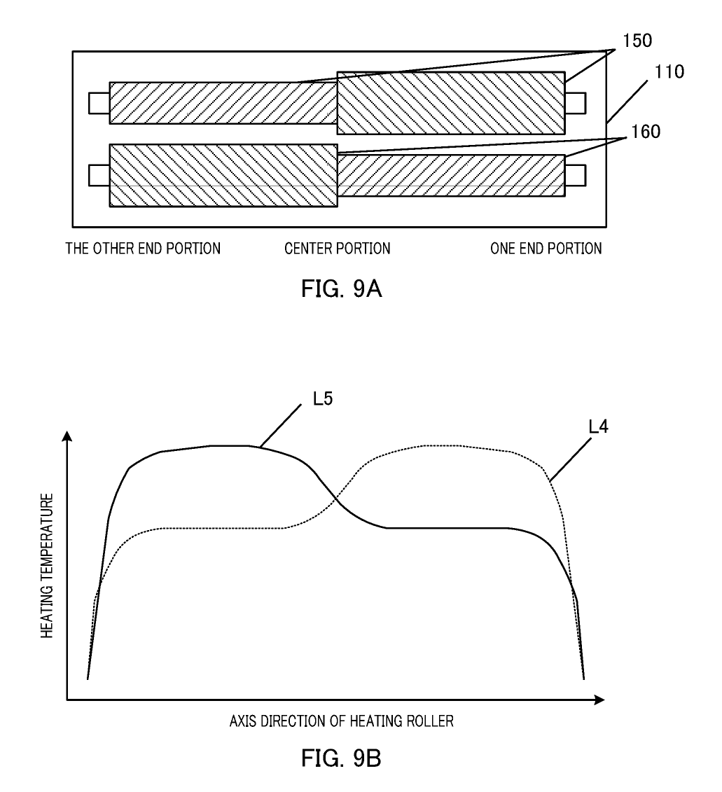

It is to be noted that, in the above-mentioned embodiment, heater unit 110 may include fourth heater 150 (which corresponds to “first heating member” of the embodiment of the present invention) and fifth heater 160 (which corresponds to “second heating member” of the embodiment of the present invention) as illustrated in FIG. 9A. FIG. 9A illustrates heater unit 110 as viewed in the direction orthogonal to the longitudinal direction of heater unit 110 (which corresponds to the axis direction of heating roller 61). Each of fourth heater 150 and fifth heater 160 is a lamp including a tubular valve and a filament extending along the axis direction in the valve.

Fourth heater 150 is formed such that it generates heat at its center portion and both end portions in the axis direction. Fourth heater 150 is configured to heat a portion between a center portion and one end portion of heating roller 61, and in turn, fixing belt 63 in the axis direction to a temperature higher than that of a portion between the center portion and the other end portion. That is, as indicated with the dotted line L4 in FIG. 9B, fourth heater 150 has a heating temperature distribution in which a portion between the center portion and one end portion has a temperature higher than that of a portion between the center portion and the other end portion, and the left and right end portions and the center portion are connected by a predetermined temperature gradient. The length of third heater 140 in the axis direction corresponds to the width of a large sheet such as an A4 sheet, for example.

Fifth heater 160 is formed such that it generates heat at its center portion and both end portions in the axis direction. Fifth heater 160 is configured to heat a portion between a center portion and the other end portion of heating roller 61, and in turn, fixing belt 63 in the axis direction to a temperature higher than that of the center portion and one end portion thereof. As indicated with solid line L5 in FIG. 9B, fifth heater 150 has a heating temperature distribution in which a portion between the center portion and the other end portion has a temperature higher than that of a portion between the center portion and one end portion, and the left and right end portions and the center portion are connected by a predetermined temperature gradient. The length of fifth heater 160 in the axis direction corresponds to the width of a large sheet such as an A4 sheet, for example.

Under a command output from control section 100, fourth heater 150 and fifth heater 160 selectively turn on (generate heat) or turn off (generate no heat).

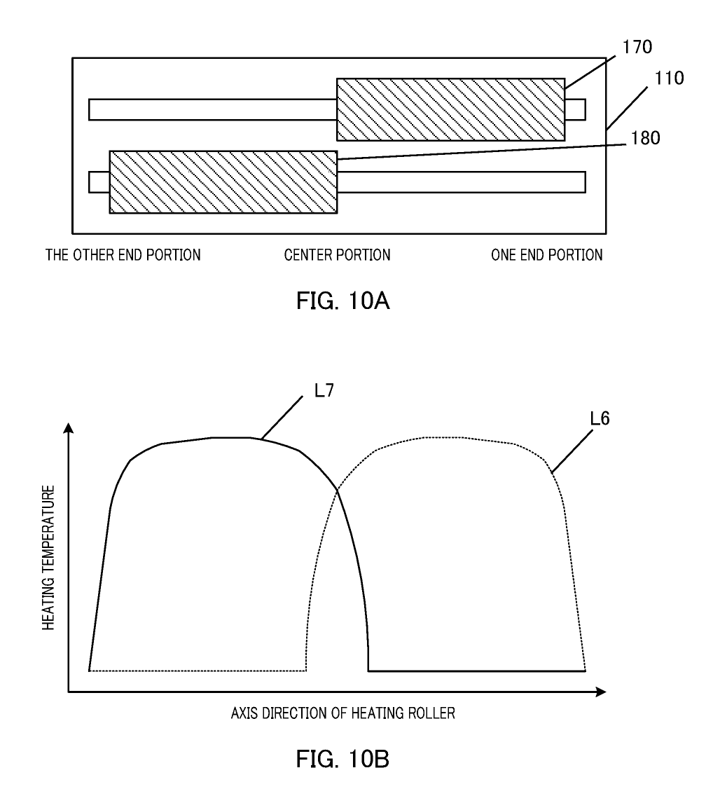

In addition, in the above-mentioned embodiment, heater unit 110 may include sixth heater 170 (which corresponds to “first heating member” of the embodiment of the present invention) and seventh heater 180 (which corresponds to “second heating member” of the embodiment of the present invention) as illustrated in FIG. 10A.

Sixth heater 170 is formed such that the filament extending from a center portion to one end portion in the axis direction generates heat when sixth heater 170 is energized. Sixth heater 170 is configured to heat a portion between a center portion and one end portion of heating roller 61, and in turn, fixing belt 63 in the axis direction to a high temperature. That is, as indicated with dotted line L6 in FIG. 10B, sixth heater 170 has a heating temperature distribution in which a portion between the center portion and one end portion has a high temperature, and one end portion and the center portion are connected by a predetermined temperature gradient.

Seventh heater 180 is formed such that the filament extending from the center portion to the other end portion in the axis direction generates heat when seventh heater 180 is energized. Seventh heater 180 is configured to heat a portion between a center portion and the other end portion of heating roller 61, and in turn, fixing belt 63 in the axis direction to a high temperature. That is, as indicated with solid line L7 in FIG. 10B, seventh heater 180 has a heating temperature distribution in which a portion between the center portion and the other end portion has a high temperature, and the other end portion and the center portion are connected by a predetermined temperature gradient.

The sum of the length of the filament extending from the center portion to one end portion of sixth heater 170 in the axis direction and the length of the filament extending from the center portion to the other end portion of seventh heater 180 in the axis direction corresponds to the width of a large sheet such as an A4 sheet, for example.

Under a command output from control section 100, sixth heater 170 and seventh heater 180 selectively turn on (generate heat) or turn off (generate no heat).

While, in the above-mentioned embodiment, control section 100 controls the heating amount of the first and second heating members on the basis of the difference between the temperature detected by temperature detection section 82 configured to detect the temperature of the fixing member (hereinafter referred to as “detection temperature”) and the target temperature of the fixing member (hereinafter referred to as “target temperature”), this control based on the difference between the detection temperature and the target temperature is merely an example, and the control is not limited to this. For example, the heater may be turned on or off at a timing where the detection temperature reaches the target temperature. Specifically, the temperature transition of the fixing member when such a control is performed is as follows. When the detection temperature is lower than the target temperature, control section 100 requests to turn on the heater. Thereafter, when the detection temperature reaches the target temperature, control section 100 requests to turn off the heater. In response to the turn off of the heater, the rising of the detection temperature is moderated at a temperature slightly greater than the target temperature (overshooting), and after the temperature peak is reached, the temperature is dropped. When the detection temperature higher than the target temperature is dropped and when the detection temperature again reaches the target temperature in response to the turning off of the heater, control section 100 requests to turn on the heater. In response to the tuning on of the heater, the detection temperature increases at a temperature slightly lower than the target temperature (undershooting), and increases toward the target temperature. The target temperature can be maintained by repeating the above-mentioned control.

In addition, in the above-mentioned embodiment, control section 100 may calculate the operation ratio of first heater 120 with use of the following Expression (4). That is, the operation ratio of first heater 120 may be calculated as expressed by Expression (4) in the form of a fraction in which the fans that are required to increase the operation ratio of first heater 120 to reduce the temperature of the near side of the apparatus main body are expressed as the numerators, and the fans that are required to reduce the operation ratio of first heater 120 to uniformly reduce the temperature from the near side to the far side of the apparatus main body are expressed as the denominators. In this case, each of coefficients 3 to 6 for multiplying the operation outputs of the fans is a positive value.

operation ratio (%) of first heater 120=(operation output of apparatus interior cooling fan 220×coefficient 3+operation output of fixation exhaust fan 230×coefficient 4)/(operation output of separation fan 240×coefficient 5+operation output of pressure roller cooling fan 250×coefficient 6) (4)

Table 2 shows a relationship between the coefficients used for calculating the operation ratio of first heater 120 for the fans, and the operation output of the fans in accordance with the operation state of image forming apparatus 1. Table 2 also shows results of calculation of the operation ratio of first and second heaters 120 and 130 by Expression (4). As shown in Table 2, when the operation ratio is determined based on the operation statuses (operation outputs) of apparatus interior cooling fan 220, fixation exhaust fan 230, separation fan 240 and pressure roller cooling fan 250, the operation ratio of first heater 120 during the idling state is 68%, which is higher than the operation ratio (32%) of second heater 130 during the idling state. In addition, during the image formation process, the operation ratio of first heater 120 is 47%, which is slightly lower than the operation ratio (53%) of second heater 130.

TABLE 2

Operation output

| | | Idling | Image formation |
|---|---|---|---|
| | Coefficient | state | state |
| Apparatus interior | +0.2 | 30% | 100% |
| cooling fan | | | |
| Fixation exhaust fan | +0.6 | 50% | 100% |
| Separation fan | +2.0 | 0% | 90% |
| Pressure roller | +1.5 | 20% | 50% |
| cooling fan | | | |

| | | |
|---|---|---|
| Operation ratio of first heater | 68% | 47% |
| Operation ratio of second heater | 32% | 53% |

In addition, in the above-mentioned embodiment, control section 100 may calculate the operation ratios of first and second heaters 120 and 130 in consideration of the change of the influence on the temperature distribution of the fixing nip in the axis direction due to the temperature in image forming apparatus 1, the print history or the continuous sheet passage. With this configuration, the temperature distribution of the fixing nip in the axis direction can be further accurately uniformized.

For example, control section 100 may calculate the operation ratios of first and second heaters 120 and 130 in accordance with the change of the operation statuses of the fans and the change of the temperature in image forming apparatus 1 (apparatus interior temperature) with use of the following Expression (5).

operation ratio of first heater 120=initial operation ratio of first heater 120−operation ratio maximum correction amount×(apparatus interior temperature−reference temperature)/(maximum apparatus interior temperature−reference temperature) (5)

In Expression (5), the operation ratio maximum correction amount is a maximum value of the operation ratio that changes due to increase of the apparatus interior temperature and continuous sheet passage. The reference temperature is the apparatus interior temperature at the time when the initial operation ratio is calculated (for example, 20° C.). The maximum apparatus interior temperature is a maximum temperature of the apparatus interior temperature which increases due to continuous sheet passage and the like during normal use of the apparatus. Exemplary preset values of the parameters used in Expression (5) are shown in Table 3.

TABLE 3

| Parameter | Preset value |
|---|---|
| Operation ratio of first heater | 60% |
| (Initial state) | |
| Operation ratio maximum | 10% |
| correction amount | |
| Apparatus interior temperature | 30° C. |
| Reference temperature | 20° C. |
| Maximum apparatus interior | 40° C. |
| temperature | |

The operation ratio of first heater 120 is 60% when the apparatus interior temperature is 20° C. that is the reference temperature, and the operation ratio of first heater 120 is slightly reduced to 55% when the apparatus interior temperature is increased to 30° C.

In addition, in the above-mentioned embodiment, control section 100 may change the operation ratios of first and second heaters 120 and 130 in accordance with the change of the operation statuses of the fans and the change of the image formation conditions in image forming apparatus 1 (number of continuously conveyed sheets) with use of the following Expression (6).

operation ratio of first heater 120=initial operation ratio of first heater 120−operation ratio maximum correction amount×(number of continuously conveyed sheets/predetermined maximum number of sheets) (6)

Here, the predetermined maximum number of sheets is 5,000. Exemplary preset values of the parameters used in Expression (6) are shown in Table 4.

TABLE 4

| Parameter | Preset value |
|---|---|
| Operation ratio of first heater | 60% |
| (initial state) | |
| Operation ratio maximum | 10% |
| correction amount | |
| Number of continuously | 3,000 |
| conveyed sheets | |
| Predetermined maximum | 5,000 |
| number of sheets | |

The operation ratio of first heater 120 is 60% at the time of start of sheet passage, but is slightly reduced to 54% after 3,000 sheets are continuously conveyed.

While the operation ratios of first and second heaters 120 and 130 are changed in accordance with the change of the operation statuses of the fans provided in image forming apparatus 1 to change the heating amounts of first and second heaters 120 and 130 in the above-mentioned embodiment, the method for changing the heating amount of first and second heaters 120 and 130 is not limited to this.

It should be understood by those skilled in the art that various modifications, combinations, sub-combinations and alterations may occur depending on design requirements and other factors in so far as they are within the scope of the appended claims or the equivalents thereof. While the invention made by the present inventor has been specifically described based on the preferred embodiments, it is not intended to limit the present invention to the above-mentioned preferred embodiments but the present invention may be further modified within the scope and spirit of the invention defined by the appended claims. The present invention is applicable to an image formation system composed of a plurality of units including an image forming apparatus. The units include, for example, a post-processing apparatus, an external apparatus such as a control apparatus connected with a network, and the like.

1. An image forming apparatus comprising:
a fixing member configured to heat a toner image on a sheet to fix the toner image;
a heating section including a plurality of heating members configured to supply heat to the fixing member;
a plurality of airflow generation members configured to generate airflows, the airflows being different from each other in influence on a temperature of the fixing member in an axis direction;
a temperature detection section configured to detect the temperature of the fixing member; and
a control section configured to control a heating amount of the heating section on a basis of the temperature detected by the temperature detection section and a target temperature of the fixing member, wherein
the control section controls the heating amount of the heating section in accordance with operation statuses of the airflow generation members such that the temperature of the fixing member in the axis direction is uniform.

2. The image forming apparatus according to claim 1, wherein
the temperature detection section detects a temperature of one of end portions of the fixing member in the axis direction.

3. The image forming apparatus according to claim 1, wherein
the heating section includes a first heating member configured to heat one end portion of the fixing member in the axis direction to a temperature higher than that of the other end portion of the fixing member, and a second heating member configured to heat the other end portion to a temperature higher than that of the one end portion.

4. The image forming apparatus according to claim 3, wherein
the heating section includes a third heating member configured to heat a center portion of the fixing member in the axis direction to a temperature higher than those of the one end portion and the other end portion,
the first heating member heats the one end portion to a temperature higher than those of the center portion and the other end portion, and
the second heating member heats the other end portion to a temperature higher than those of the center portion and the one end portion.

5. The image forming apparatus according to claim 3, wherein
the first heating member heats a portion between the center portion and the one end portion of the fixing member in the axis direction to a temperature higher than that of a portion between the center portion and the other end portion of the fixing member in the axis direction, and
the second heating member heats a portion between the center portion and the other end portion of the fixing member in the axis direction to a temperature higher than that of a portion between the center portion and the one end portion of the fixing member in the axis direction.

6. The image forming apparatus according to claim 1, wherein the airflow generation members generate airflow that provides a gradient to a temperature distribution of the fixing member in the axis direction.

7. The image forming apparatus according to claim 1, wherein
the airflow generation members generate airflow that uniformizes a temperature distribution of the fixing member in the axis direction.

8. The image forming apparatus according to claim 1, wherein
the control section controls the heating amount of the heating section in accordance with the operation statuses of the airflow generation members and a temperature in the image forming apparatus.

9. The image forming apparatus according to claim 1, wherein
the control section controls the heating amount of the heating section in accordance with the operation statuses of the airflow generation members and an image formation status in the image forming apparatus.

10. The image forming apparatus according to claim 1, wherein
the control section determines the heating amount of the heating section in accordance with the operation statuses of the airflow generation members when the image forming apparatus is in an idling state.

11. An image formation system comprising a plurality of units including an image forming apparatus, the image formation system including:
a fixing member configured to heat a toner image on a sheet to fix the toner image;
a heating section including a plurality of heating members configured to supply heat to the fixing member;
a plurality of airflow generation members configured to generate airflows, the airflows being different from each other in influence on a temperature of the fixing member in an axis direction;
a temperature detection section configured to detect the temperature of the fixing member; and
a control section configured to control a heating amount of the heating section on a basis of the temperature detected by the temperature detection section and a target temperature of the fixing member, wherein
the control section controls the heating amount of the heating section in accordance with operation statuses of the airflow generation members such that the temperature of the fixing member in the axis direction is uniform.

12. The image formation system according to claim 11, wherein
the temperature detection section detects a temperature of one of end portions of the fixing member in the axis direction.

13. The image formation system according to claim 11, wherein
the heating section includes a first heating member configured to heat one end portion of the fixing member in the axis direction to a temperature higher than that of the other end portion of the fixing member, and a second heating member configured to heat the other end portion to a temperature higher than that of the one end portion.

14. The image formation system according to claim 13, wherein
the heating section includes a third heating member configured to heat a center portion of the fixing member in the axis direction to a temperature higher than those of the one end portion and the other end portion,
the first heating member heats the one end portion to a temperature higher than those of the center portion and the other end portion, and
the second heating member heats the other end portion to a temperature higher than those of the center portion and the one end portion.

15. The image formation system according to claim 13, wherein
the first heating member heats a portion between the center portion and the one end portion of the fixing member in the axis direction to a temperature higher than that of a portion between the center portion and the other end portion of the fixing member in the axis direction, and
the second heating member heats a portion between the center portion and the other end portion of the fixing member in the axis direction to a temperature higher than that of a portion between the center portion and the one end portion of the fixing member in the axis direction.

16. The image formation system according to claim 11, wherein
the airflow generation members generate airflow that provides a gradient to a temperature distribution of the fixing member in the axis direction.

17. The image formation system according to claim 11, wherein
the airflow generation members generate airflow that uniformizes a temperature distribution of the fixing member in the axis direction.

18. The image formation system according to claim 11, wherein
the control section controls the heating amount of the heating section in accordance with the operation statuses of the airflow generation members and a temperature in the image forming apparatus.

19. The image formation system according to claim 11, wherein
the control section controls the heating amount of the heating section in accordance with the operation statuses of the airflow generation members and an image formation statuses in the image forming apparatus.

20. The image formation system according to claim 11, wherein
the control section determines the heating amount of the heating section in accordance with the operation statuses of the airflow generation members when the image forming apparatus is in an idling state.

21. A heating control method in an image forming apparatus, the image forming apparatus including:
a fixing member configured to heat a toner image on a sheet to fix the toner image;
a heating section including a plurality of heating members configured to supply heat to the fixing member;
a plurality of airflow generation members configured to generate airflows, the airflows being different from each other in influence on a temperature of the fixing member in an axis direction;
a temperature detection section configured to detect the temperature of the fixing member; and
a control section configured to control a heating amount of the heating section on a basis of the temperature detected by the temperature detection section and a target temperature of the fixing member, the heating control method comprising:
controlling the heating amount of the heating section in accordance with operation statuses of the airflow generation members such that the temperature of the fixing member in the axis direction is uniform.
